(19) United States
(12) Patent Application Publication
(10) Pub. No.: US 2017/0271919 A1
(43) Pub. Date: Sep. 21, 2017

(54) WIRELESS IMPLANT POWERING VIA SUBCUTANEOUS POWER RELAY

(71) Applicant: QUALCOMM Incorporated, San Diego, CA (US)

(72) Inventors: William Henry VON NOVAK, III, San Diego, CA (US); Mei-Li CHI, San Diego, CA (US); Ravindra SHENOY, Dublin, CA (US); Rashid Ahmed Akbar ATTAR, San Diego, CA (US); Karim ARABI, San Diego, CA (US); Donald KIDWELL, JR., Los Gatos, CA (US); Jon LASITER, Stockon, CA (US)

(21) Appl. No.: 15/267,639

(22) Filed: Sep. 16, 2016

Related U.S. Application Data
(60) Provisional application No. 62/310,978, filed on Mar. 21, 2016.

(51) Int. Cl. H02J 50/05; H02J 50/15; H02J 50/90; H02J 50/12

(52) U.S. Cl. CPC H02J 50/05; H02J 50/12; H02J 50/15; H02J 50/90

(57) ABSTRACT

A method of providing power to an implant includes: transcutaneously receiving first power wirelessly from a source transmitter by a receiver of a power relay device, the receiver of the power relay device being disposed inside a biological body and closer to a skin of the biological body than the implant is to the skin of the biological body; converting the first power into second power that has a substantially different frequency than the first power, or is of different type of power than the first power, or both; and internally coupling the second power from a transmitter of the power relay device to the implant disposed within the biological body.

### CROSS-REFERENCE TO RELATED APPLICATIONS

This application claims the benefit of U.S. Provisional Application No. 62/310,978, filed Mar. 21, 2016, entitled “WIRELESS IMPLANT POWERING VIA SUBCUTANEOUS POWER RELAY,” the entire contents of which is hereby incorporated herein by reference, and which is assigned to the assignee hereof.

### TECHNICAL FIELD

The disclosure relates generally to wireless power delivery to implantable electronic devices, and in particular to power relay techniques for wireless power transfer for implantable electronic devices.

### BACKGROUND

An increasing number and variety of electronic devices are powered via rechargeable batteries. Such devices include mobile phones, portable music players, laptop computers, tablet computers, computer peripheral devices, communication devices (e.g., BLUETOOTH devices), digital cameras, hearing aids, and the like. While battery technology has improved, battery-powered electronic devices increasingly require and consume greater amounts of power. As such, these devices frequently require recharging. Rechargeable devices are often charged via wired connections that require cables or other similar connectors that are physically connected to a power supply. Cables and similar connectors may sometimes be inconvenient or cumbersome and have other drawbacks. Wireless power charging systems may allow users to charge and/or power electronic devices without physical, electro-mechanical connections, thus simplifying the use of the electronic device.

Further, an increasing number of electronic devices are being implanted in patients. For example, implantable electronic devices include pace makers, cochlear implants, retinal implants, and biometric monitoring systems for monitoring a variety of parameters such as blood characteristics. Wired recharging of these devices is often undesirable. For example, it is typically desired for an implant to be small such that a large, non-rechargeable battery is impractical and/or undesirable and a small rechargeable battery is desirable.

### SUMMARY

An example power relay device includes: a housing configured to be disposed inside of a biological body; a receiver disposed in the housing and configured to receive first power wirelessly from a power source disposed outside of the biological body while the receiver is disposed inside the biological body; and a power conversion and transmission circuit disposed in the housing, operably coupled to the receiver, and configured to convert the first power into second power and to transmit the second power to an implant disposed in the biological body, the second power having a substantially different frequency than the first power, or being of a different type of power than the first power, or both.

Another example power relay device includes: receiving means for receiving first power wirelessly from a power source disposed outside of a biological body while the receiving means are disposed inside the biological body proximate to an interior surface of the biological body; and converting and transmitting means, operably coupled to the receiving means, for converting power received by the receiving means into second power and transmitting the second power, the second power having a substantially different frequency than the first power, or being of a different type of power than the first power, or both.

An example method of providing power to an implant includes: transcutaneously receiving first power wirelessly from a source transmitter by a receiver of a power relay device, the receiver of the power relay device being disposed inside a biological body and closer to a skin of the biological body than the implant is to the skin of the biological body; converting the first power into second power that has a substantially different frequency than the first power, or is of different type of power than the first power, or both; and internally coupling the second power from a transmitter of the power relay device to the implant disposed within the biological body.

### BRIEF DESCRIPTION OF THE DRAWINGS

Drawing elements that are common among the following figures may be identified using the same reference numerals.

With respect to the discussion to follow and in particular to the drawings, the particulars shown represent examples for purposes of illustrative discussion, and are presented in the cause of providing a description of principles and conceptual aspects of the disclosure. In this regard, no attempt is made to show implementation details beyond what is needed for a fundamental understanding of the disclosure. The discussion to follow, in conjunction with the drawings, makes apparent to those of skill in the art how embodiments in accordance with the disclosure may be practiced.

FIG. 1 is a simplified side view of a power relay device that relays power from an external power source to an implanted device in a patient.

FIG. 2 is a functional block diagram of an example of a wireless power transfer system.

FIG. 3 is a functional block diagram of an example of another wireless power transfer system.

FIG. 4 is a schematic diagram of an example of a portion of transmit circuitry or receive circuitry of the system shown in FIG. 3.

FIG. 5 is a functional block diagram of a power source, a power relay device, and an implant.

FIG. 6 is a functional block diagram of a low-frequency or direct-current power transfer element for wireless direct current power transfer.

FIG. 7 is a simplified front view of low-frequency or direct current power receiving element.

FIG. 8 is a simplified view of a coil power transfer element and a coil power receiving element.

FIG. 9 is a simplified view of a power transfer element, comprising a coil with a high-mu material, outside a patient and a power receiving element, comprising a high-mu material, inside the patient.

FIG. 10 is a simplified view of a sonic power transfer element outside a patient and a sonic power receiving element inside the patient.

FIG. 11 is a simplified view of a light pipe disposed between a power relay device and an implant in a patient.

FIG. 12 is a simplified diagram of an example of a power relay device shown in FIG. 5.

FIG. 13 is a block flow diagram of a method of providing power wirelessly to an implant.

### DETAILED DESCRIPTION

Wireless power transfer may refer to transferring any form of energy associated with electric fields, magnetic fields, electromagnetic fields, or otherwise from a transmitter to a receiver without physical electrical conductors attached to and connecting the transmitter to the receiver to deliver the power (e.g., power may be transferred through free space). The power output into a wireless field (e.g., a magnetic field or an electromagnetic field) may be received, captured by, or coupled to by a power receiving element to achieve power transfer. The transmitter transfers power to the receiver through a wireless coupling of the transmitter and receiver.

Techniques are discussed herein for wirelessly providing power to an implant in a patient in a multi-stage process, e.g., a two-stage process. For example, power may be provided from a power source external to the patient to a power relay device disposed inside the patient, and power sent from the power relay device to the implant. The power relay device is preferably disposed close to a surface of the patient for receiving power from the power source. The power source is configured to send power to the power relay device, and the power relay device is configured to receive power, in a form that passes transcutaneously well, e.g., without large power loss or at least with less power loss than other forms. The power relay device is configured to send power to the implant, and the implant is configured to receive power, in a manner that propagates through the patient well, e.g., without large power loss or at least with less power loss than other forms. The power source may transfer power to the power relay device in one manner and the power relay device may transfer power to the implant in another manner. For example, the power source may transfer power transcutaneously to the power relay device with magnetic or light coupling, and the power relay device may transfer power to the implant using sonic coupling or light coupling through a transparent medium inserted into the patient. The term “patient” as used herein refers generally to a body, e.g., a person or other animal, in which an implant is placed and does not require any particular status (e.g., being under the care of a physician, being in a hospital) of the body. These examples, however, are not exhaustive.

Items and/or techniques described herein may provide one or more of the following capabilities, as well as other capabilities not mentioned. Wireless power transfer efficiency from outside a patient to an implant inside a patient may be improved, e.g., by using different power transfer techniques for transcutaneous power transfer and patient-internal power transfer. Less power may be transferred transcutaneously to power an implant wirelessly than with prior techniques. More diffuse power transfer may be used transcutaneously to power an implant wirelessly than with prior techniques. What battery size is used in an implant may be dependent upon a depth of the implant in an entity (e.g., a patient), and/or distance from a power source for powering the implant. A wired connection between implants may be avoided, and thus risk of breakage of the wired connection, risk of infection, and risk of a wired connection acting as an antenna and heating surrounding tissue (e.g., during an MRI of an entity containing the implants), may be avoided. Multiple implants, including a deep implant (an implant disposed, for example, 5 cm or more from a surface of an entity containing the deep implant) may be inserted into a patient using minimally-invasive surgery. Flexibility of shallow implant placement may be improved. Advantages of ultrasound power transfer (e.g., lower attenuation, higher permitted intensity than with radio-frequency energy) may be realized without using a gel or requiring physical contact of a power source with a patient. Energy may be better directed toward an implant, e.g., a deep implant. Required alignment of a transmitter and a receiver in a wireless power system may be reduced. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

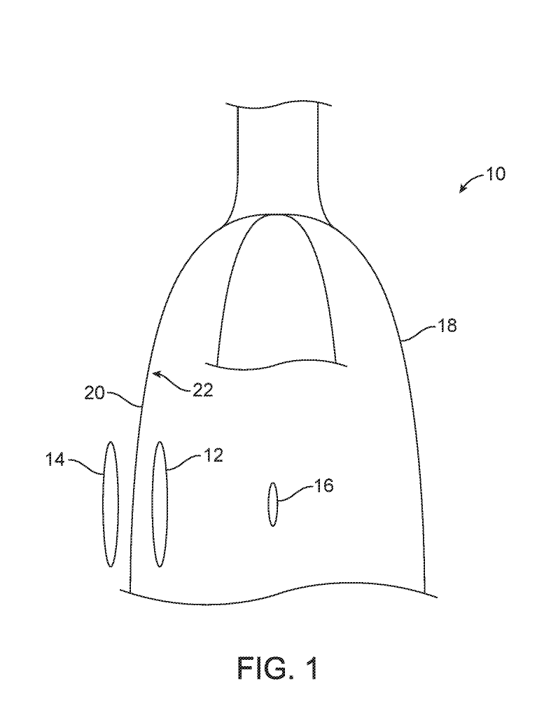

Referring to FIG. 1, in a wireless power implant charging environment 10 a power relay device 12 is disposed between a power source 14 and an implant 16. The power source 14 is disposed outside of a biological body 18, here a person's body, while the power relay device 12 and the implant 16 are disposed inside the body 18. The power relay device 12 is preferably disposed near the body's skin 20, while the implant 16 is disposed deeper inside the body 18, displaced from the skin 20 more than the power relay device 12, at least relative to the power source 14 (e.g., the implant 16 could be close to a different portion of the skin 20, possibly even closer to that portion of the skin 20 than the power relay device 12 is to the skin 20 between the power source 14 and the power relay device 12). If the implant 16 is disposed further from the skin 20 than the power relay device 12, then the power relay device may be referred to as a shallow implant and the implant 16 may be referred to as a deep implant. The power relay device 12 is configured to wirelessly receive power from the source 14 and to wirelessly transfer power to the implant 16, preferably more efficiently than power can be transferred from the source 14 to the implant 16 without the power relay device 12. For example, radio frequency (RF) energy at 2 GHz may be attenuated about 3 dB/cm in tissue while ultrasound (US) energy at 1 MHz may be attenuated about 1 dB/cm in tissue. Further, the Food and Drug Administration (FDA) permits higher intensity ultrasonic energy (e.g., 7.2 mW/mm²) to be used with a person than RF energy (e.g., 0.1 mW/mm²). The power relay device 12 has a receiver to receive power from the source 14 and a transmitter to transmit power to the implant 16. These components may take any of various forms, examples of which are discussed in detail below. The source 14 and the power relay device 12 form a wireless power transfer system and the power relay device and the implant 16 form another wireless power transfer system.

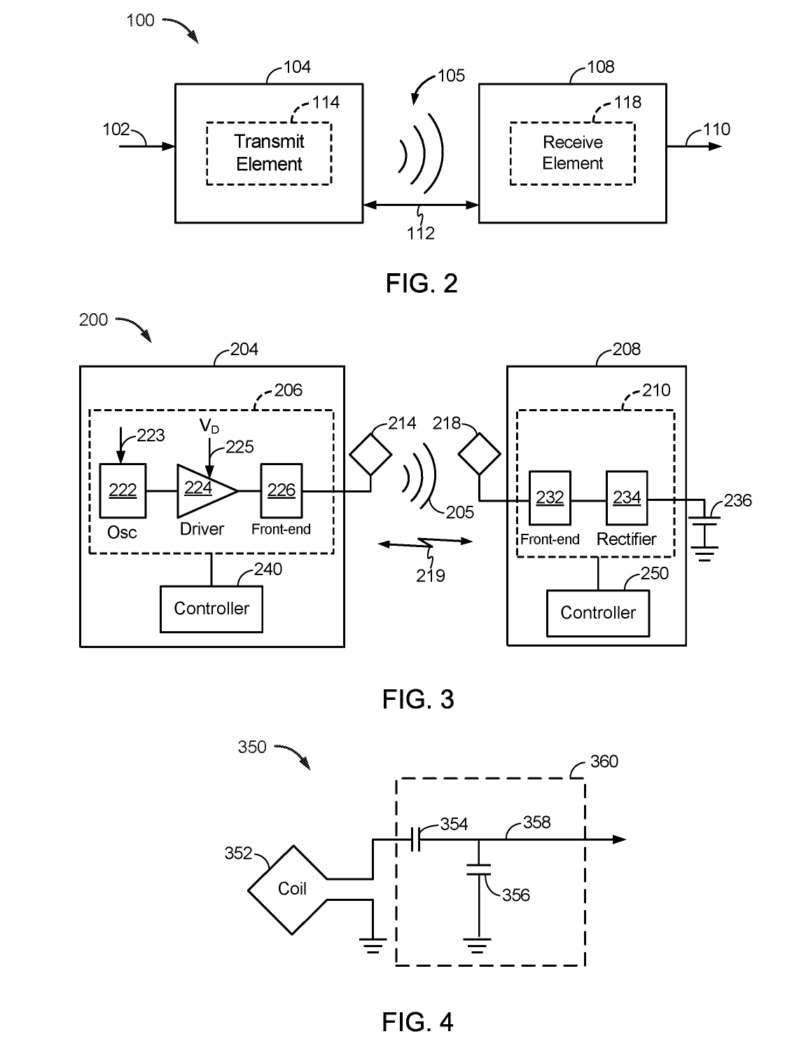

FIG. 2 is a functional block diagram of an example of a wireless power transfer system 100. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) that is coupled to receive the output power 110. The transmitter 104 and the receiver 108 are separated by a non-zero distance 112. The transmitter 104 includes a power transmitting element 114 configured to transmit/couple energy to the receiver 108. The receiver 108 includes a power receiving element 118 configured to receive or capture/couple energy transmitted from the transmitter 104.

The transmitter 104 and the receiver 108 may be configured according to a mutual resonant relationship. When the resonant frequency of the receiver 108 and the resonant frequency of the transmitter 104 are substantially the same, transmission losses between the transmitter 104 and the receiver 108 are reduced compared to the resonant frequencies not being substantially the same. As such, wireless power transfer may be provided over larger distances when the resonant frequencies are substantially the same. Resonant inductive coupling techniques allow for improved efficiency and power transfer over various distances and with a variety of inductive power transmitting and receiving element configurations.

The wireless field 105 may correspond to the near field of the transmitter 104. The near field corresponds to a region in which there are strong reactive fields resulting from currents and charges in the power transmitting element 114 that do not significantly radiate power away from the power transmitting element 114. The near field may correspond to a region that up to about one wavelength, of the power transmitting element 114. Efficient energy transfer may occur by coupling a large portion of the energy in the wireless field 105 to the power receiving element 118 rather than propagating most of the energy in an electromagnetic wave to the far field.

The transmitter 104 may output a time-varying magnetic (or electromagnetic) field with a frequency corresponding to the resonant frequency of the power transmitting element 114. When the receiver 108 is within the wireless field 105, the time-varying magnetic (or electromagnetic) field may induce a current in the power receiving element 118. As described above, with the power receiving element 118 configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge an energy storage device (e.g., a battery) or to power a load.

The transmitter 104 may output acoustic energy that is transmitted via the power transmitting element 114, e.g., a transducer, coupled to the power receiving element 118, e.g., a transducer. When the receiver 108 is within the range of the acoustic signal, the acoustic energy may induce a current in the power receiving element 118. With the power receiving element 118 configured as a resonant element to resonate at the frequency of the power transmitting element 114, energy may be more efficiently transferred. An alternating current (AC) signal induced in the power receiving element 118 may be rectified to produce a direct current (DC) signal that may be provided to charge an energy storage device (e.g., a battery) or to power a load.

The transmitter 104 may output electrical energy which is conducted through the skin to the receiver 108. For example, the power transmitting element 114 may be two conductive pads situated close to two corresponding conductive pads within the power receiving element 118. A current may then flow between each pad pair. This current may be DC, or may be low frequency AC (e.g., up to approximately 1 MHz). This signal may be rectified and/or conditioned as appropriate to charge an energy storage device (e.g., a battery) or to power a load.

FIG. 3 is a functional block diagram of an example of a wireless power transfer system 200. The system 200 includes a transmitter 204 and a receiver 208. The transmitter 204 (also referred to herein as power transmitting unit, PTU) is configured to provide power to a power transmitting element 214 that is configured to transmit power wirelessly to a power receiving element 218 that is configured to receive power from the power transmitting element 214 and to provide power to the receiver 208. Despite their names, the power transmitting element 214 and the power receiving element 218, being passive elements, may transmit and receive power and communications.

The transmitter 204 includes the power transmitting element 214, transmit circuitry 206 that includes an oscillator 222, a driver circuit 224, and a front-end circuit 226. The power transmitting element 214 is shown outside the transmitter 204 to facilitate illustration of wireless power transfer using the power receiving element 218. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or powering a load.

The transmitter 204 further includes a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by the controller 240. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) includes the power receiving element 218, and receive circuitry 210 that includes a front-end circuit 232 and a rectifier circuit 234. The power receiving element 218 is shown outside the receiver 208 to facilitate illustration of wireless power transfer using the power receiving element 218. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 3. The receiver 208 and the transmitter 204 may additionally communicate on a separate communication channel 219 (e.g., BLUETOOTH, ZIGBEE, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. The transmitter 204 may be configured to generate a predominantly non-radiative field with a direct field coupling coefficient (k) for providing energy transfer. The receiver 208 may directly couple to the wireless field 205 and may generate an output power for storing or consumption by a battery (or load) 236 coupled to the output or receive circuitry 210.

The receiver 208 further includes a controller 250 that may be configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to try to minimize transmission losses between the transmitter 204 and the receiver 208.

FIG. 4 is a schematic diagram of an example of a portion of the transmit circuitry 206 or the receive circuitry 210 of FIG. 2. While a coil, and thus an inductive system, is shown in FIG. 3, other types of systems, such as capacitive systems for coupling power, may be used, with the coil replaced with an appropriate power transfer (e.g., transmit and/or receive) element. As illustrated in FIG. 3, transmit or receive circuitry 350 includes a power transmitting or receiving element 352 and a tuning circuit 360. The power transmitting or receiving element 352 may also be referred to or be configured as an antenna such as a “loop” antenna. The term “antenna” generally refers to a component that may wirelessly output energy for reception by another antenna and that may receive wireless energy from another antenna. The power transmitting or receiving element 352 may also be referred to herein or be configured as a “magnetic” antenna, such as an induction coil (as shown), a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356, which may be added to the transmit or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. For example, the tuning circuit in the front-end circuit 226 may have the same design (e.g., 360) as the tuning circuit in the front-end circuit 232. Alternatively, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

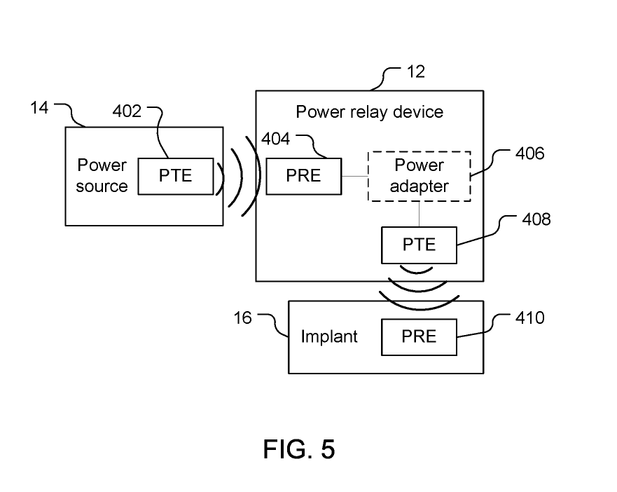

Referring to FIG. 5, with further reference to FIGS. 1-4, the power source 14 includes a power transmitting element (PTE) 402, the power relay device 12 includes a power receiving element (PRE) 404, optionally a power adapter 406, and a power transmitting element 408, and the implant 16 includes a power receiving element 410. The power transmitting elements 402, 408 are examples of the transmit element 114 and the power receiving elements 404, 410 are examples of the receive element 118. The power transmitting element 402 and the power receiving element 404 are configured for transcutaneous power transfer, although the body 18, including the skin 20, is not shown in FIG. 5 for simplicity. The power adapter 406 is configured to provide power received by the power receiving element 404 to the power transmitting element 408, with the power adapter 406 and/or the transmitting element 408 actively converting the received power as appropriate, i.e., to a different type of power and/or a different frequency, e.g., from AC power of one frequency to AC power of another frequency, or from acoustic energy to near-field or mid-field magnetic energy, etc. The received power may not be converted to a different type of power until transmitted by the transmitting element 408. The power adapter 406 may convert received energy for use by the power transmitting element 408. For example, the power adapter 406 may be configured to receive energy from the power receiving element 404, possibly convert the energy (e.g., from AC to DC), possibly store the energy (e.g., in a battery that is part of the power adapter 406), possibly convert the stored energy (e.g., from DC to AC of a desired frequency), and provide the energy to the power transmitting element 408 for transmission of power to the power receiving element 410. The power adapter 406 is optional, and the power receiving element 404 may couple or connect to the power transmitting element 408 such that received energy is transformed into transmitted energy, with or without being actively converted. For example, the power receiving element 404 may comprise a first diaphragm that is mechanically coupled to a second diaphragm of the power transmitting element 408 to transform the received energy that induces vibrations in the first diaphragm into vibrations of the second diaphragm. The second diaphragm is preferably well matched to the material, e.g., tissue, between the power relay device 12 and the implant 16. The power transmitting element 408 and the power receiving element 410 are configured for deep-link power transfer, i.e., power transfer inside the body 18. The input impedance of the power receiving element 404 is preferably well matched to the impedance from the power receiving element 404 toward the power transmitting element 402. Similarly, the input impedance of the power receiving element 410 is preferably well matched to the impedance from the power receiving element 410 toward the power transmitting element 408.

The power relay device 12 may be configured such that the power receiving element 404 and the power transmitting element 408 have different configurations. For example, the power relay device 12 (e.g., the receiver 108, in particular the power receiving element 404) may be configured to receive one type and/or frequency of energy and (e.g., the transmitter 104, and particularly the power transmitting element 408) to transmit a different type and/or a substantially different frequency of energy. For example, the power receiving element 404 may be configured to receive light energy (e.g., infrared light) and the power transmitting element 408 may be configured to transmit ultrasound energy, e.g., with a frequency between 1 MHz and 3 MHz. The different types of energy and/or the substantially different frequencies of energy are such that a receiver or transmitter for a first type or first frequency will not receive or transmit any significant energy (i.e., an amount of energy sufficient to power an implant independently, e.g., less than 20 mW) at a second type or a second frequency that is substantially different from the first frequency. For example, RF energy at 2 GHz may be used to transfer power from the power source 14 to the power relay device 12 and ultrasound energy with a frequency of 1 MHz may be used to transfer power from the power relay device 12 to the implant 16. The ultrasound energy may have an attenuation of about 1 dB/cm between the power relay device 12 and the implant 16 while the RF energy would have an attenuation of about 3 dB/cm between the power relay device 12 and the implant 16, but be better suited to transition the impedance change caused by the junction of air and skin between the power source 14 and the power relay device 12. The power receiving element 404 is configured to receive power wirelessly from the power source 14 disposed outside the body 18 while the power receiving element 404 is disposed inside the body 18 proximate to an interior surface 22 of the skin 20.

The power receiving element 404 may be configured to allow diffuse coupling of power from the power source 14 to the power relay device 12. Diffuse power coupling may help prevent damage to the body 18 due to an undesirable power density, e.g., that may induce unacceptable amounts of heat. For example, the power receiving element 404 may have a dimension (e.g., length or diameter) transverse to a direction from the power source 14 to the power relay device 12 that is greater than 10 cm, e.g., 15 cm or 20 cm or 30 cm. Thus, the power receiving element 404 may span 10 cm or more roughly parallel to a surface of the body 18 through which the power receiving element 404 will receive power. This diffuse coupling may permit more power at a lower power density to be provided to the power relay device 12 and used by the power transmitting element 408 to couple power to the implant 16 than could be safely provided to a smaller power relay device, at least using the type of power used by the power transmitting element 402 and the power receiving element 404. The power conveyed by the power source 14 to the power relay device 12 may be kept within acceptable specific absorption rate limits for the body 18. The diffuse power coupling may permit the power relay device 12 to couple more power, than otherwise available, to the implant 16 using a focused power coupling using a different type of power than was used to provide power to the power relay device 12.

Various configurations of the power transmitting element 402, the power receiving element 404, the power transmitting element 408, and the power receiving element 410 are possible and examples are discussed below.

Transcutaneous Power Transfer

Transcutaneous power coupling from the source 14 to the power relay device 12 provides a link between the source 14 outside the body 18 and the power relay device 12 disposed under the skin 20. Since animal skin is generally thin and relatively transparent, there are several means by which power can be transferred from the source 14 to the power relay device 12.

Direct Current or Low Frequency Coupling

Since the skin 20, when damp or wet, has a relatively low resistance, a low frequency or DC current can be passed through damp or wet skin to the power relay device 12. This power transfer can be made more effective by using a large area, e.g., 10 cm²-100 cm², to reduce current density in the skin 20. In this case, two transmitting elements and two receiving elements may be used to help ensure a complete circuit. The power relay device 12 may adjust its input impedance to improve the power transfer to the power receiving element 404.

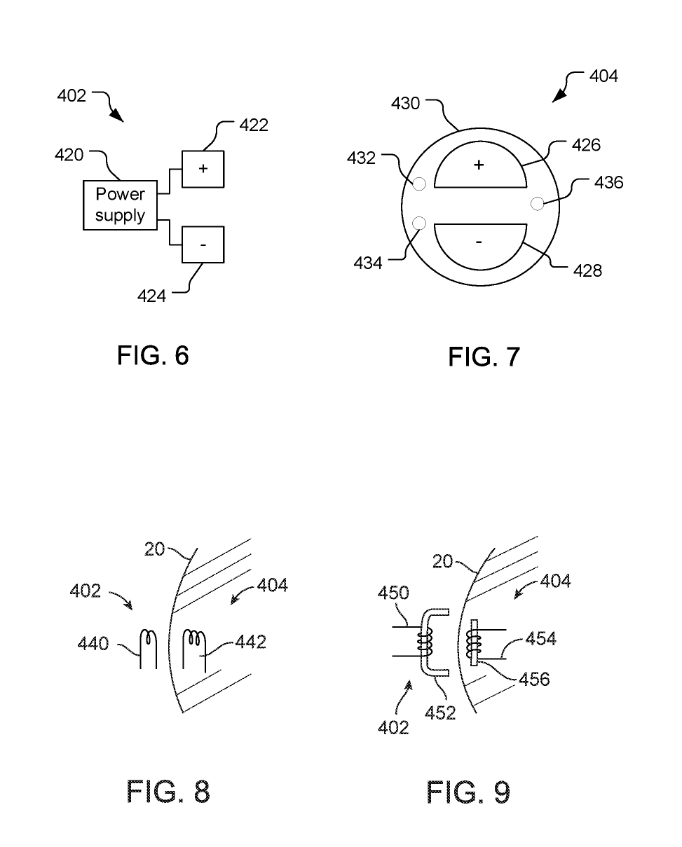

Referring also to FIGS. 6-7, for low frequency or DC power transfer, the power transmitting element 402 comprises a power supply 420, charging pads 422, 424, and the power receiving element 404 comprises conductors 426, 428 disposed on an insulator 430. The power supply 420 is configured to provide energy at a low frequency, for example, a frequency below 1 MHz, e.g., in the hundreds of kilohertz, and/or DC energy. The power supply 420, the charging pads 422, 424, and the conductors 426, 428 are configured to form a circuit through the skin 20 to transfer power from the power transmitting element 402 to the power receiving element 404. The conductors 426, 428 may be coupled to a battery (not shown) to store energy received from the power transmitting element 402 and/or may be coupled to the power transmitting element 408 directly. The battery may be part of the power adapter 406.

The power receiving element 404 may be placed just below the skin 20 in an accessible area. The two external conductive charging pads 422, 424 may be placed on the skin 20 in the vicinity of the conductors 426, 428. To help align the charging pads 422, 424 and the conductors 426, 428, tactile markings 432, 434, 436 on the power receiving element 404, palpable through the skin 20, may be used to delineate the area to guide placement of the charging pads 422, 424. Either DC or low frequency AC may be transmitted through the charging pads 422, 424 to the conductors 426, 428.

Medium Frequency Coupling

Near-field coupling via either a magnetic field or an electric field can be used to couple power from the power source 14 to the power relay device 12. In general, the magnetic or electric field will be strong enough to power the power relay device 12 but below the exposure limits for that type of radiation (e.g., either SAR (specific absorption rate) or ICNIRP (international commission on non-ionizing radiation protection) limits). Medium frequencies may, for example, be between 100 KHz and 40 MHz.

Referring to FIGS. 8-9, two configurations of the power transmitting element 402 and the power receiving element 404 for magnetic-field coupling include coils either with or without the use of high-mu material. As shown in FIG. 8, the power transmitting element 402 includes a coil 440 and the power receiving element 404 includes a coil 442. The coils 440, 442 are aligned, although precise alignment is not required, with the skin 20 disposed between the coil 440, 442. As shown in FIG. 9, the power transmitting element 402 includes a coil 450 disposed about bar 452 made of a high-mu material such as ferrite, and the power receiving element 404 includes a coil 454 disposed about bar 456 made of a high-mu material such as ferrite. The high-mu material may improve efficiency of energy transfer from the coil 450 to the coil 454. In this case, good alignment is desirable, and may be achieved by aligning poles of the power transmitting element 402 with extents of the power receiving element 404. As above, tactile markings (not shown), palpable through the skin 20, may delineate the area to guide placement of the power transmitting element 402. Also or alternatively, magnets may be used to provide a reference for accurate placement of the power transmitting element 402.

High Frequency, Light, and Sonic Coupling

Power may be coupled transcutaneously using high frequencies or light. For high-frequency coupling, e.g., above 1 GHz, each of the power transmitting element 402 and the power receiving element 404 comprise an antenna for an appropriate frequency, preferably a frequency that propagates well through the skin 20. In most cases, antenna designs appropriate for mid- or far-field coupling, such as dipole antennas, are used. For light coupling (photonic coupling), a light-frequency signal, e.g., between 400 nm and 2,000 nm wavelength) is coupled from the power transmitting element 402 to the power receiving element 404. For example, the power transmitting element 402 may be configured to transmit, and the power receiving element 404 configured to receive, infrared light because human skin is relatively transparent to infrared light. Thus, the skin barrier will not be very lossy to infrared light. For example, at 904nm, skin losses are generally less than 10 dB. The power receiving element 404 could be one or more light receptors, e.g., an array of light receptors. For example, the power receiving element 404 may comprise one or more photovoltaic semiconductor cells that can be configured for specific frequencies of light. For example, 904nm represents a photon energy of 1.37 electron-volts. Any photovoltaic material with a bandgap energy lower than this will convert that wavelength of light into energy. The closer the bandgap is to the photon energy the more efficient the conversion. For this example, photovoltaic cells made of doped silicon (bandgap of 1.11 eV) or doped indium phosphide (bandgap of 1.35 eV) would be good choices for the photovoltaic receiver. In most cases, since the voltage generated by a photovoltaic cell is low (on the order of 600 mV), a boost circuit may be used to boost the voltage to more useful levels to allow device powering or battery charging.

Power may also or alternatively be coupled transcutaneously using sonic power coupling. For example, the power transmitting element 402 may comprise a transducer configured to convert electrical energy from a power supply to ultrasound waves. The transducer may send an ultrasonic signal through the skin 20 to the power receiving element 404 disposed under the skin 20 such that the ultrasonic signal is coupled to the power receiving element 404. Power may be coupled from the power transmitting element 402 to the power receiving element 404 using ultrasound with high coupling efficiencies, especially if the power transmitting element 402 is in close proximity to the power receiving element 404. The power transmitting element 402 may be configured to transmit, and the power receiving element 404 to receive, ultrasound signals, e.g., with a frequency between 1 MHz and 3 MHz. For sonic coupling, accurate alignment is preferred, and techniques discussed above (e.g., tactile markings, magnets) as well as other alignment techniques may be used to help align the power transmitting element 402 and the power receiving element 404.

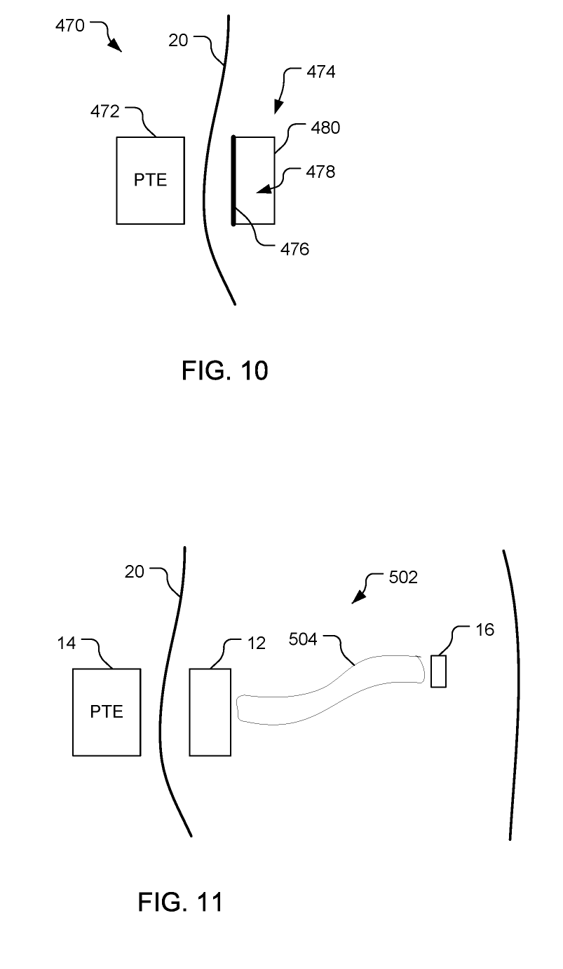

Referring to FIG. 10, with further reference to FIGS. 1 and 5, a transcutaneous coupling environment 470 includes a sonic example of the power transmitting element 402, here a power transmitting element 472, and a sonic example of the power receiving element 404, here a power receiving element 474. The power transmitting element 472 comprises an ultrasound transducer and the power receiving element 474 comprises a piezoelectric plate 476 covering a cavity 478 provided by a housing or base 480. The base 480 is configured such that the cavity 478 permits transmission of sound waves and is preferably resonant at a frequency transmitted by the power transmitting element 472, allowing for better power reception by the piezoelectric plate 476 than if the cavity 478 was not resonant. Electric charge produced by the piezoelectric plate 476 may be used to drive the power transmitting element 408.

Internal Power Transfer

Internal power coupling from the power relay device 12 to the implant 16 transfers power received from the transcutaneous power transfer to the implant 16. This power transfer from the power relay device 12 to the implant 16 may be referred to as a deep link. Various parameters may be configured to improve power transfer from the power relay device 12 to the implant 16. For example, configurable parameters may include size and/or placement of the power relay device 12, type of energy transfer (e.g., ultrasound, magnetic, etc.) from the power relay device 12, etc. As with transcutaneous power transfer, there are several means by which power can be transferred from the power relay device 12 to the implant 16.

Medium Frequency Coupling

Near-field coupling via either a magnetic field or an electric field can be used to couple power from the power relay device 12 to the implant 16. In general, the magnetic or electric field will be strong enough to power the implant 16 but below the exposure limits for that type of radiation (e.g., either SAR or ICNIRP limits). Medium frequencies may, for example, be between 100 KHz and 40 MHz. The power transmitting element 408 and the power receiving element 410 may be coils without or without high-mu material, similar to the configurations shown in FIGS. 8-9 for the power transmitting element 402 and the power receiving element 404. In this case, good alignment is desirable, and relative orientation of the power transmitting element 408 and the power receiving element 410 is preferably managed to help ensure good coupling is maintained between the power relay device 12 and the implant 16. For example, the power relay device 12 may be constrained by the plane of the skin, and may thus have an internal transmitting surface of the power relay device 12 oriented towards the implant 16. Likewise, the implant 16 may be attached to a specific structure (such as a nerve, blood vessel or bone) that limits motion of the implant 16 and keeps one surface largely oriented towards the power relay device.

High Frequency Coupling

Power may be coupled through the body 18 using high frequencies. For high-frequency coupling, e.g., above 1 GHz, each of the power transmitting element 408 and the power receiving element 410 comprise an antenna for an appropriate frequency, preferably a frequency that propagates well through the body 18. Indeed, the frequency may be chosen based on how well various frequencies propagate through the body 18 and the frequency used may be the one determined to best propagate from the power relay device 12 to the implant 16. The form factors of the antennas will depend on the sizes of the power relay device 12 and the implant 16. Both antennas may be directional with the degree of directionality determined by the relative constraints on their orientations. For example, the power transmitting element 408 may be designed to be directional (i.e. a quadrifilar helix or phased array antenna) since it is well constrained by the skin, but the power receiving element 410 may be designed to be more omnidirectional (i.e. a dipole antenna) if it allowed more freedom of motion.

Light Coupling

Power may be coupled through the body 18 using light. For light coupling (photonic coupling), a light-frequency signal, e.g., between 400 nm and 2,000 nm wavelength) is coupled from the power transmitting element 408 to the power receiving element 410. For example, the power transmitting element 408 may be configured to transmit, and the power receiving element 410 configured to receive, light of a frequency that travels well through the intervening tissue, i.e., the tissue between the power relay device 12 and the implant 16. That is, the frequency used will be chosen to take advantage of the transparency or translucency of the tissue in the deep link. Also or alternatively, transparency may be aided by providing a high-transparency material between the power relay device 12 and the implant 16. For example, referring to FIG. 11, with further reference to FIGS. 1 and 5, a deep link environment 502 includes a light pipe 504 disposed between the power relay device 12 and the implant 16. Examples of the light pipe 504 include a fiber optic cable or a transparent bag containing saline. The light pipe 504 may be a natural or implanted transparent structure to assist with light transmission.

Sonic Coupling

Power may also or alternatively be coupled from the power relay device 12 to the implant 16 using sonic power. For example, the power transmitting element 408 may comprise a transducer configured to convert electrical energy from a power supply to ultrasound waves. The transducer (for example a piezoelectric actuator excited by a high voltage) may send an ultrasonic signal through the tissue between the power relay device 12 and the implant 16 such that the ultrasonic signal is coupled to the power receiving element 410. Power may be coupled from the power transmitting element 408 to the power receiving element 410 using ultrasound with high coupling efficiencies (for example, 0.2% to 10%) because the tissue in the deep link is not very lossy to ultrasound signals. The power transmitting element 408 may be configured to transmit, and the power receiving element 410 to receive, ultrasound signals, e.g., with a frequency between 1 MHz and 3 MHz. The power transmitting element 408 may be directional, and aimed toward the power receiving element 410 by implanting the power relay device 12 with the appropriate side facing the implant 16. The power relay device 12 could be a power concentrator, i.e., that takes a diffuse energy coupling through the skin and focuses the power for transmission to the implant 16. For example, the power receiving element 404 could be a large coil, e.g., 10 cm-30 cm in diameter, and the power transmitting element 408 could be much smaller, e.g., a coil less than 1 cm. As another example, the power receiving element 404 could focus light from a large area, e.g., up to 20 cm or even 30 cm across, down to an optical fiber or other optical conductor, e.g., a saline bag, for transmission to the implant 16.

Power Relay Device with an RF Receiver and an Ultrasound Transmitter

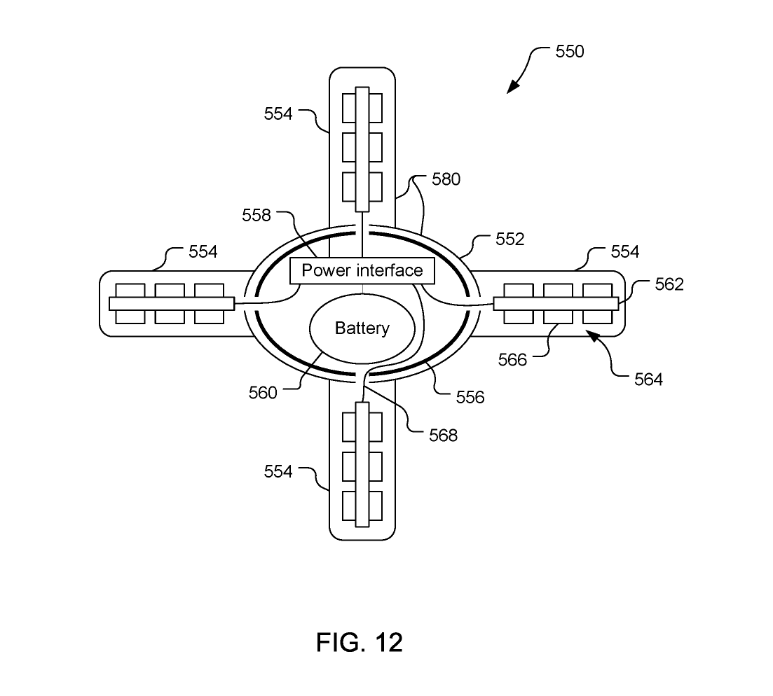

Referring to FIG. 12, with further reference to FIG. 5, a power relay device 550, which is an example of the power relay device 12, includes a housing 580 that includes a central housing 552 and arms 554. The power relay device 550 (or another example of the power relay device 12) may be configured to provide power to multiple implants. The central housing 552 contains a power receiving element 556, a power interface 558, and a battery 560. The power interface 558 and the battery 560 are example components of the power adapter 406 shown in FIG. 5. Each of the arms 554 includes a power feed mechanism 562 and an array 564 of ultrasound transducers 566. The ultrasound transducers 566 together are an example of the power transmitting element 408 shown in FIG. 5. The power relay device 550 is configured to receive radio frequency power through the power receiving element 556, and to convert the received energy and to transmit the converted energy as ultrasound energy through the ultrasound transducers 566. The ultrasound transducers 566 may be, for example bulk-machined piezo ultrasound devices or micro-electro-mechanical systems (MEMS) ultrasound devices operated with piezo or capacitive elements. The power relay device 550 is configured to receive radio frequency power inductively through a magnetic field, but may receive other frequencies of power, and in other examples of power relay devices, power may be received by capacitive coupling, from an electromagnetic field, etc.

The power receiving element 556 is configured to receive radio-frequency energy from the power source 14. In this example, the power receiving element 556 is a solenoid configured to inductively couple with the power transmitting element 402 of the power source 14 to receive power from the power source 14. The power receiving element 556 is electrically coupled to the power interface 558 to convey received energy to the power interface 558.

The power interface 558 is configured to process energy from the power receiving element 556 and provide the processed energy to the battery 560. For example, the power interface 558 may be configured to process one type of energy to another, e.g., to process the received RF energy into direct current (DC) energy. The power interface 558 is further configured to provide the processed energy, in this example the DC energy, to the battery 560 as the power interface 558 is electrically coupled to the battery 560. The battery 560 is configured to store the processed energy and to provide energy to the power interface 558 as appropriate, e.g., as requested. The power interface 558 may be configured to provide processed energy to the power feed mechanisms 562, e.g., without first being provided to the battery 560. For example, the power interface 558 may be configured to process energy into an ultrasound frequency and provide the energy at the ultrasound frequency to the power feed mechanisms 562.

The power interface 558 is further configured to draw or receive energy from the battery 560, to process this energy into outbound energy for use by the power feed mechanisms 562 and the ultrasound transducers 556, and to provide the outbound energy to the power feed mechanisms 562 as the power feed mechanisms 562 are electrically coupled to the power interface 558 through lines 568. For example, the power interface 558 may draw DC energy from the battery 560, process the DC energy into AC energy with a frequency between 1 MHz and 3 MHz as the outbound energy, and provide an equal portion of the outbound energy to each of the power feed mechanisms 562.

The power feed mechanisms 562 and the transducers 566 are configured to convert the outbound energy to ultrasound energy and to transmit the ultrasound energy, e.g., for reception by the implant 16. Each of the power feed mechanisms 562 is configured to distribute, e.g., equally, the respective share of the outbound energy received by the power feed mechanism 562 to the ultrasound transducers 566 associated with the power feed mechanism 562. The transducers 566 are configured to receive the electrical outbound energy from the respective power feed mechanism, convert this energy into ultrasound energy, and transmit the ultrasound energy. The transducers 566 may also incorporate phase delays to allow more directional transmission of energy using phased-array antenna techniques. The arms 554 may be filled with a coupling medium that may increase an effective area of the transducers 566, which may help improve directionality of the transmitted ultrasound energy. Increasing directionality may help reduce the amount of power needed to be received by the power relay device 550 in order to provide sufficient charging energy to the implant 16 to charge the implant 16. The coupling medium would preferably be a polymer (with few if any voids) that forms a bond between the ultrasound transducer 566 and an inner wall of the power relay device 550.

The transducers 566 may be any of a variety of transducers. For example, the transducers 566 may be piezo microelectromechanical ultrasound transducers (PMUTs). MEMS transducers may comprise aluminum nitride, which may be smaller than bulk-machined transducers comprising lead zirconate titanate (PZT). The transducers 566 are preferably MEMS transducers as MEMS technology helps miniaturize the transducers 566. Other configurations of transducers may, however, be used. Further, other layouts of the transducers 566 may be used. For example, the transducers 566 may be disposed inside the central housing 552, or disposed about the central housing 552 in a layout other than in the arms 554, e.g., disposed around a perimeter of the central housing 552, or other layout.

The configuration of the arms 554 help the power relay device 550 to transmit energy and to insert the power relay device 550 into a patient through a surgical tool. The arms 554 contain the transducers 566 such that the transducers 566 are disposed over a large area relative to the central housing 552 and in an array of transmitters. This allows for increased ultrasound energy transmission directionality and increased efficiency of energy transmitted by the power relay device 550 to energy received by the implant 16. Further, the arms 554 are preferably configured to be foldable relative to the central housing 552 such that the arms 554 can be folded to be disposed close to the central housing 552 during insertion into a patient through a surgical tool and unfolded so that the arms 554 are extended away from the central housing 552 (as shown in FIG. 12) for transmission of ultrasound energy to the implant 16. To facilitate the folding, the lines 568 would be flexible connectors.

Various configurations and quantities of the arms 554 may be used. In the example power relay device 550 shown in FIG. 12 there are four arms, but other quantities of arms, e.g., one, two, three, more than four, may be used. Further, the arms 554 may have any of various shapes, such as fins that are relatively flat, or cylinders, or other shapes.

Further, a configuration of ultrasound transducers, e.g., using arms similar to the arms 554, may be provided as the power receiving element 410 of the implant 16. In this case, the transducers in the arms are used to receive ultrasound energy that may be processed and stored in a battery of the implant 16. The use of such arms helps provide a large area over which energy may be received and, particularly where multiple arms are used, may reduce the need for good alignment between the power transmitting element 408 of the power relay device 12 and the power receiving element 410 of the implant 16.

Operation

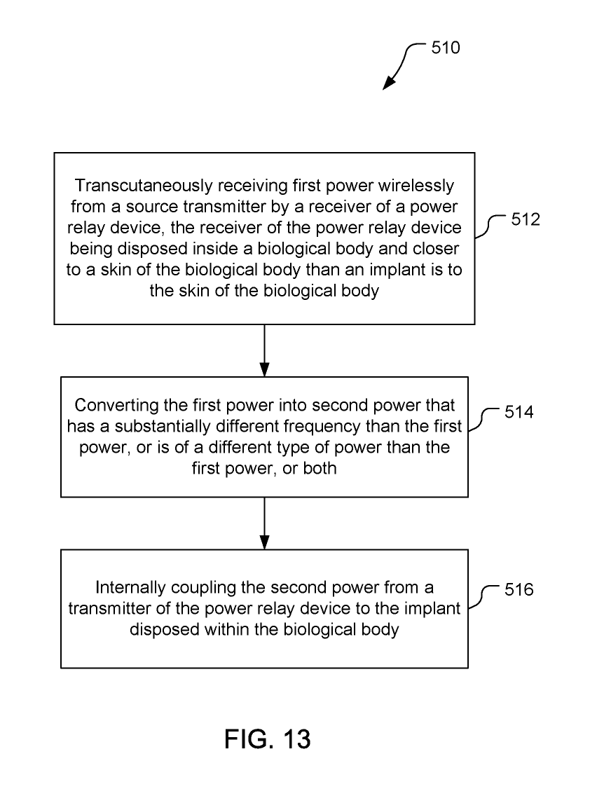

Referring to FIG. 13, with further reference to FIGS. 1-12, a method 510 of providing power wirelessly to an implant includes the stages shown. The method 510 is, however, an example only and not limiting. The method 510 can be altered, e.g., by having stages added, removed, rearranged, combined, performed concurrently, and/or having single stages split into multiple stages.

At stage 512, the method 510 includes transcutaneously receiving first power wirelessly from a source transmitter by a receiver of a power relay device, the receiver of the power relay device being disposed inside the biological body and closer to a skin of the biological body than the implant is to the skin of the biological body. For example, the power receiving element 404 of the power relay device 12 receives power coupled from the power transmitting element 402 of the power source 14, that is disposed outside the biological body. The coupling may be of DC power, low-frequency power, medium-frequency power, high-frequency power, radio-frequency power, light, ultrasound, etc. The power coupling may use one or more of the example mechanisms shown in FIGS. 6-10 and discussed above, and/or another mechanism. The method 510 may further comprise transmitting power from the source transmitter (e.g., the power transmitting element 402) with an output impedance matched to the impedance of the biological body from the skin to the power relay device.

At stage 514, the method 510 includes converting the first power into second power that has a substantially different frequency than the first power, or is of different type of power than the first power, or both. Converting the received first power into the converted second power comprises changing a type of power (energy per time) received to a different power transmitted and/or changing a frequency of the power received to a substantially different frequency of power transmitted. As power is energy per time, a different type of power and a different type of energy are treated as equivalent herein. Thus, active converting causes transmitted energy to be of a different type and/or substantially different frequency than energy received. The active converting may use energy that is separate from, e.g., in addition to, the presently-received energy to convert the presently-received energy. For example, using the power relay device 510, as an example of the power relay device 12, the power interface 558 may use energy from the battery 560, e.g., that was not from energy wirelessly received from the power source 14 (e.g., was stored during manufacture or before being implanted) or that was from previously-received energy from the power source 14, to convert presently-received energy from the power source 14 into energy to be stored in the battery 560 and/or energy to be used by the transducers 566. Alternatively, the active converting may use only the presently-received energy to produce the transmitted energy.

Converting the power may be completed without transducing and before transmission of the converted power (e.g., where the received and converted powers are the same type) or may be completed when power is transduced (e.g., where the received and converted power are of different types), which may be when the power is transmitted. The received power may be directly or indirectly provided to a transmitter. For an example of indirect provision of received power to the transmitter, the power interface 558 may receive and process energy from the power receiving element 556, provide the processed energy to the battery 560, later withdraw the energy from the battery 560, and provide the withdrawn energy to the power feed mechanisms 562 for delivery to the transducers 566 that are each a transmitter, or may be collectively considered to be a transmitter, e.g., the power transmitting element 408 shown in FIG. 5. As another example of indirect provision of the received power, the power interface 558 may receive energy from the power receiving element 556, process the received energy, and provide the processed energy to the power feed mechanisms 562. For direct provision of the received power, the power receiving element 556 may provide the received power to the power feed mechanisms 562, and the power feed mechanisms 562 may adjust a frequency of the provided power as appropriate.

At stage 516, the method 510 includes internally coupling the second power from a transmitter of the power relay device to the implant disposed within the biological body. As discussed above, the converted second power may be a different type of power than received and/or may have a substantially different frequency than the power received. For example, the power transmitting element 408 couples power of the power relay device 12 to the power receiving element 410 of the implant 16. The coupling may be of low-frequency power, medium-frequency power, high-frequency power, radio-frequency power, light, ultrasound, etc. The power coupling may use one or more of the example mechanisms discussed above for the internal coupling, and/or another mechanism. The transcutaneous coupling may use a first type of power coupling and the internal coupling may use a second type of power coupling, different from the first type of power coupling. The first type of power coupling or the second type of power coupling may comprise inductive coupling, capacitive coupling, light transmission, or ultrasound transmission. For example, the first type of power coupling may be inductive coupling at an RF frequency and the second type of power coupling may be ultrasound coupling, e.g., with a frequency between 1 MHz and 3 MHz. The internally coupling power may comprise wirelessly coupling power from the power relay device to the implant. The internally coupling power may comprise mid-field power coupling. The internally coupling power may comprise power transmission of energy with a frequency between 200 MHz and 5 GHz. The internally coupling may comprise outputting power from the transmitter of the power relay device with an output impedance well matched to an impedance of the biological body from the power relay device to the implant.

Other Considerations

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being coupled, connected, or communicating with each other are operably coupled. That is, they may be directly or indirectly, wired or wirelessly, connected to enable signal flow between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. A power relay device comprising:
a housing configured to be disposed inside of a biological body;
a receiver disposed in the housing and configured to receive first power wirelessly from a power source disposed outside of the biological body while the receiver is disposed inside the biological body; and
a power conversion and transmission circuit disposed in the housing, operably coupled to the receiver, and configured to convert the first power into second power and to transmit the second power to an implant disposed in the biological body, the second power having a substantially different frequency than the first power, or being of a different type of power than the first power, or both.

2. The device of claim 1, wherein the receiver is configured to receive a first type of power as the first power and the power conversion and transmission circuit is configured to configured to convert the first type of power into, and to transmit, a second type of power as the second power, the first type of power being a different type of power than the second type of power.

3. The device of claim 2, wherein:
the receiver is configured to receive the first power through inductive coupling, capacitive coupling, light transmission, or ultrasound transmission; and
the power conversion and transmission circuit is configured to transmit the second power through inductive coupling, light transmission, or ultrasound transmission.

4. The device of claim 2, wherein:
the receiver is configured to receive the first power through radio-frequency transmission; and
the power conversion and transmission circuit is configured to transmit the second power through ultrasound transmission.

5. The device of claim 2, wherein:
the receiver is configured to receive the first power through inductive coupling; and
the power conversion and transmission circuit is configured to transmit the second power through ultrasound transmission.

6. The device of claim 1, wherein the power conversion and transmission circuit is configured to transmit ultrasonic power with a frequency between 1 MHz and 3 MHz.

7. The device of claim 1, wherein the receiver is configured to receive the first power wirelessly from a power source while the receiver is disposed inside the biological body and proximate to an interior surface of the biological body.

8. The device of claim 1, wherein the receiver includes a power receiving element having a length or diameter between 10 cm and 30 cm.

9. A power relay device comprising:
receiving means for receiving first power wirelessly from a power source disposed outside of a biological body while the receiving means are disposed inside the biological body proximate to an interior surface of the biological body; and
converting and transmitting means, operably coupled to the receiving means, for converting power received by the receiving means into second power and transmitting the second power, the second power having a substantially different frequency than the first power, or being of a different type of power than the first power, or both.

10. The device of claim 9, wherein the receiving means are for receiving a first type of power and the converting and transmitting means are for converting the first type of power into a second type of power and transmitting the second type of power as the second power, the first type of power being a different type of power than the first type of power.

11. The device of claim 10, wherein:
the receiving means are for receiving the first power through inductive coupling, capacitive coupling, light transmission, or ultrasound transmission; and
the converting and transmitting means are for transmitting the second power through inductive coupling, light transmission, or ultrasound transmission.

12. The device of claim 10, wherein:
the receiving means are for receiving the first power through radio-frequency transmission; and
the converting and transmitting means are for transmitting the second power through ultrasound transmission.

13. The device of claim 9, wherein the converting and transmitting means are for transmitting ultrasonic power with a frequency between 1 MHz and 3 MHz.

14. The device of claim 9, wherein the receiving means include a power receiving element having a length or diameter between 10 cm and 30 cm.

15. A method of providing power to an implant, the method comprising:
transcutaneously receiving first power wirelessly from a source transmitter by a receiver of a power relay device, the receiver of the power relay device being disposed inside a biological body and closer to a skin of the biological body than the implant is to the skin of the biological body;
converting the first power into second power that has a substantially different frequency than the first power, or is of different type of power than the first power, or both; and
internally coupling the second power from a transmitter of the power relay device to the implant disposed within the biological body.

16. The method of claim 15, wherein the transcutaneously receiving the first power uses a first type of power coupling and the internally coupling the second power uses a second type of power coupling, different from the first type of power coupling.

17. The method of claim 16, wherein:
the first type of power coupling comprises inductive coupling, capacitive coupling, light transmission, or ultrasound transmission; and
the second type of power coupling comprises a different one of inductive coupling, light transmission, or ultrasound transmission than the first type of power coupling.

18. The method of claim 17, wherein the first type of power coupling comprises radio-frequency transmission, and the second type of power coupling comprises ultrasound transmission.

19. The method of claim 17, wherein the first type of power coupling comprises inductive coupling, and the second type of power coupling comprises ultrasound transmission.

20. The method of claim 17, wherein the first type of power coupling comprises light transmission, and the second type of power coupling comprises ultrasound transmission.

21. The method of claim 17, wherein the first type of power coupling comprises capacitive coupling, and the second type of power coupling comprises ultrasound transmission.

22. The method of claim 15, wherein the internally coupling wirelessly couples the second power from the power relay device to the implant.

23. The method of claim 15, wherein the internally coupling comprises mid-field power coupling.

24. The method of claim 23, wherein the internally coupling comprises power transmission using a frequency between 200 MHz and 5 GHz.

25. The method of claim 15, further comprising transmitting the first power from the source transmitter with an output impedance matched to an impedance of the biological body from the skin to the power relay device.

26. The method of claim 15, wherein the internally coupling the second power comprises outputting power from the transmitter of the power relay device with an output impedance matched to an impedance of the biological body from the power relay device to the implant.
